(19) United States
(12) Patent Application Publication
(10) Pub. No.: US 2026/0338472 A1
(43) Pub. Date: Oct. 29, 2026

(54) GAS INJECTOR FOR SHAFT INJECTION IN A BLAST FURNACE

(71) Applicant: PAUL WURTH S.A., Luxembourg (LU)

(72) Inventors: Klaus Peter KINZEL, Sandweiler (LU); Christian DE GRUITER, Bergem (LU); Philipp KRÄMER, Trier (DE)

(21) Appl. No.: 19/106,087

(22) PCT Filed: Aug. 28, 2023
(86) PCT No.: PCT/EP2023/073505

§ 371 Date: Feb. 24, 2025

(30) Foreign Application Priority Data
Aug. 29, 2022 (LU) LU502720

(51) Int. Cl. F27B 1/16; C21B 7/10; C21B 7/16; F27D 3/16; F27D 9/00

(52) U.S. Cl. CPC F27B 1/16; C21B 7/10; C21B 7/16; F27D 3/16; F27D 9/00; F27D 2003/166; F27D 2009/0067

(57) ABSTRACT

An injector for injecting a hot gas, in particular for injecting a heated reduction gas in a furnace or reactor, includes a tubular body extending along a main axis between a mounting portion configured for fixing the injector to the furnace and a nose portion to be arranged inside the furnace. The tubular body includes an inner gas passageway for guiding a heated gas from an inlet orifice at the mounting portion to at least one outlet orifice at the nose portion. The tubular body includes a feed coolant channel and a return coolant channel defined between cooperating inner and outer tubes wherein the feed and return coolant channels are formed as interlaced helical channels extending in the main axis direction in a same layer.

### CROSS-REFERENCE TO RELATED APPLICATIONS

This application is a 35 U.S.C. §371 National Stage patent application of PCT/EP2023/073505, filed on 28 Aug. 2023, which claims the benefit of Luxembourg patent application no. LU 502 720, filed on 29 Aug. 2022, the disclosures of which are incorporated herein by reference in their entirety.

### TECHNICAL FIELD

The present disclosure generally relates to the field of metallurgy and more specifically to the operation of shaft furnaces, and namely blast furnaces, wherein hot reducing gas is fed into the furnace shaft.

### BACKGROUND

With the Paris Agreement and near-global consensus on the need for action on emissions, it is imperative that each industrial sector looks into the development of solutions towards improving energy efficiency and decreasing CO₂ output.

In this context, actors in the field of iron metallurgy have developed new approaches in order to reduce the environmental footprint of the blast furnace iron making route. Indeed, despite alternative methods, like scrap melting or direct reduction within an electric arc furnace, the blast furnace (BF) today still represents the most widely used process for steel production.

One technology developed to reduce the carbon footprint during steel production is the so-called “shaft injection” wherein hot gases (mainly CO and H₂) are injected in the upper part of the blast furnace, above the cohesive zone, in the part that is generally protected on the inside by a refractory lining or cooling elements such as plates or staves or plate coolers, or cooling elements protruding in the inner wall of the furnace.

This injection of hot gas in a blast furnace or in a shaft furnace at the level of the shaft (shaft injection) is cited in many publications and disclosures, but an industrial application has not yet been implemented on a commercial blast furnace.

A gas injector for shaft feeding is e.g. disclosed in WO 2022/064046. The gas injector comprises a tubular body defining a gas passage. An coolant fluid is circulated in an annular gap.

Other designs of injectors were developed without a cooling arrangement, see e.g. WO 2022/058771. However, injectors without cooling cannot profit of the higher strength of material used at lower temperatures, also resulting in a bigger dimension.

Moreover, the prior art injectors are molded from expensive high-grade materials, and they are subjected to different (thermally-induced) stresses at many points in their bodies during use, causing some parts of the injector's body to exhibit different stress-related expansion/dilatation than others. This in turn reduces the service life and reliability of the injector.

One challenge is therefore to increase the durability and versatility of the injectors which operate in an aggressive gas atmosphere, in abrasive conditions due to solid material flow at very high temperatures and in a dusty environment.

### SUMMARY

The present disclosure provides gas injectors of improved design overcoming the above-mentioned shortcomings and meeting the desired requirements of durability and versatility.

In order to achieve the above-mentioned advantage, the present disclosure proposes an injector for injecting a hot gas, in particular a hot reduction gas. The gas injector has been particularly developed for injected a hot gas, namely a hot/heated reduction gas, in a furnace or a reactor, more specifically into a metallurgical furnace or reactor, in particular a shaft furnace or blast furnace. The injector comprises:
a tubular body extending along a main axis between a mounting portion configured for fixing the injector to the furnace and a nose portion be arranged inside the furnace, the tubular body comprising an inner gas passageway for guiding a hot gas (in particular heated reduction gas) from an inlet orifice at the mounting portion to at least one outlet orifice at the nose portion;
wherein the tubular body includes a feed coolant channel and a return coolant channel defined between cooperating inner and outer tubes, wherein the feed and return coolant channels are formed as interlaced helical channels extending in the main axis direction in a same layer.

A main benefit of the disclosure is obtained by the arrangement of the feed and return coolant channels in a same layer. Such an arrangement is possible due to the specific design of the inventive injector, wherein an inner tube and an outer tube cooperates with each other to define the feed and return channels. The feed and return channels being interlaced, they are next to one another within the same layer. Hence, they are on a same level.

The inventive design is compact: combining the feed and return channels in a same layer is more compact than e.g. having two superposed layers (one for the feed flow and the other for the return flow), which further gives more space for the passageway for reduction gases flowing through the injector or to reduce the overall outer dimensions, in particular an outer diameter, of the injector.

Another benefit of the present disclosure is that, due to the feed and return coolant channels, the injector is cooled, making it more resistant to wear and reliable against a sudden burden descent. As the coolant channels are interlaced, both coolant flows are arranged next to each other. In other words, channels with counterflowing coolant are arranged in a staggered manner. Due to the inventive arrangement of the feed and return coolant channels formed as interlaced helical channels, the surfaces of the inventive injector are cooled more evenly than surfaces of a conventional injector with a conventional cooling arrangement, thereby reducing thermal stresses of the material forming the tubes and thus reducing deformation of the injector. This provides the desired durability and versatility to the present gas injector.

Any appropriate material may be used for the injector tubular body. However, the injector body (namely the inner and outer tubes) is preferably made of steel or of alloy steel (or steel-alloy), more preferably of stainless steel or high temperature steel. High temperature steel corresponds to steel resisting corrosion due to high temperatures and keeping its strength up to temperature higher than conventional steel. High temperature steel may be e.g. the following steel grades: 1.4841; 1.5415; 1.4842; 1.4659; 1.4859; 1.4889 or similar. Alternatively, the injector body may be made from copper, copper alloy, nickel or nickel alloy.

In embodiments, the inner tube comprises two interlaced helical grooves that define the feed and return channels, the helical grooves extending from the mounting portion to the nose portion, the two helical grooves being fluidly connected at the nose portion.

Furthermore, an inlet port is arranged at the mounting portion connecting the first helical groove and an outlet port is arranged at mounting portion connecting the second helical groove. Inlet and outlet ports are advantageously connected to a coolant circulation system. Coolant (e.g. water)—from a coolant source—enters the first helical groove through the inlet port, flows through the first groove toward the nose portion, where the first and second grooves are connected, then flows back through the second helical groove toward the mounting portion where it exits the second groove through the outlet port (towards a collector duct).

One of the merits of the disclosure is relative to the size of the injector. As mentioned above, due to the specific design of the feed and return coolant channels being arranged in a same layer, the overall outer diameter of the inventive injector may be small/compact, with more space allowable for the passageway. This is achieved by specific designs of the inventive injector, wherein a ratio between an outer diameter of the outer tube and an inner diameter of the inner tube is preferably less than 2.5, less than 2 or even less than 1.5. For example, in embodiments, the outer and inner diameters may be dimensioned as follows 220/110 mm, 270/160 mm, 250/135 mm. These values are indicative only and do not limit the scope of the present disclosure.

In embodiments, the nose portion comprises an end face in which said at least one outlet orifice is arranged, said end face being at least partially inclined relative to the main axis, such that in use the end face is turned downwards. Advantageously, the inclined end face prevents descending burden from entering in the injector, thereby reducing the risk of blockage of the injector or of flow restriction.

Further advantageously, the inclined end face facilitates an even cooling of the nose portion of the inventive injector wherein the feed and return coolant channels are formed in a same layer, as the channel at the feed channel close to the tip of the nose can follow the tip at a short and substantially constant distance. This advantageously results in an even cooling, as the coolant cannot take a shortcut, contrary to what is known in the art, such as from FR 2 085 511 A1, wherein the water flow is smaller on the top because here the path for the water is longer and the resistance is thus higher.

The end face may be flat or curved. Preferably, an angle between the end face and the main axis is comprised between 10° and 60°, and more preferably 20°. However, the angle may be adapted depending of the angle of response of the material in the furnace and the size of the injector.

According to the same or other embodiments, the injector comprises a sealing arrangement between the inner and outer tubes. Preferably, the sealing arrangement comprises a helical seal interposed between the two helical grooves. In other words, the feed and return coolant channels are separated from each other by a seal arranged in a space extending between the two channels. Such a position of the seal advantageously reducing the bypass of coolant from one channel to the other even if the outer tube is deformed during operation. The helical seal may comprise any suitable material, however it preferably comprises water-swellable material, and more preferably water-swellable fibers. If one channel starts leaking, coolant (generally water) contacts the water swellable material which advantageously swells and closes the forming gap, thereby preventing further leakage of coolant.

According to the same or other embodiments, the injector further comprises a tubular, protective insert arranged in the passageway of the tubular body, defining a central passage for the reduction gas. The insert protects the inner surface of the inner tube thereby increasing its lifetime and efficiency. The protective insert is arranged inside the passageway and defines a central passage for the heated reducing gas.

The protective insert may be made of any suitable material; however it is preferably made of thermal insulation material and/or stress-resistant material and/or chemically resistant material. More preferably the insert is made of ceramic and/or dense ceramic material, such as e.g. alumina, magnesia, zirconia or silicon carbide.

Advantageously, a thermal insulation material may be arranged between the tubular body and the protective insert. A temperature loss of the injected hot reduction gas will be reduced, leading to higher reactivity of the gas and energy savings. In embodiments, the tubular protective insert has a recessed outer surface, and the thermal insulation material is provided as an outer layer in the recessed outer surface. The thermal insulation material may be provided with any desirable shape; it can be supplied as one, two or several pieces that can be formed/assembled an outer layer around the tubular protective insert. In preferred embodiments, the thermal insulation material is provided as two half cylinders that fit within the recessed outer surface of the protective insert. The thermal insulation material may generally be any material with thermal insulation properties, and preferably comprises alumina-based ceramic material or zirconia-based ceramic material, more preferably microporous ceramic and/or ceramic fibers.

In embodiments, the injector further comprises a mounting flange radially extending from the tubular body for fixing, at least indirectly, the injector to a furnace outer wall.

According to the same or other embodiments, the injector further comprises a connecting flange surrounding the mounting portion for connecting the injector to a corresponding flange of a reduction gas supply pipe of a metallurgical furnace gas injection system.

According to another aspect, the present disclosure also relates to a gas injection system for a furnace, in particular a blast furnace, comprising a furnace wall (or shell) covered at least in part with an inner a protection layer, the gas injection system comprising at least one injector according to the disclosure, wherein the injector traverses the furnace wall and the protection layer, respectively. Conventionally the protection layer may comprise refractory material and/or cooling elements. The cooling elements may include cooling boxes and/or cooling panels/cooling staves.

In case of cooling staves with internal coolant channels, the inventive design with single layer coolant channels is advantageous for its compacity, since the injector may be arranged in the plate body of the stave, in-between or adjacent the coolant channels.

The injector may be arranged through the outer wall and the protective layer such that the injector tip is flush with respect to the inner side (facing the burden/charge material) of the protective layer, or to protrude therefrom. In the latter case the injector protrudes from the inner side of the protective layer, e.g. by a distance of 50, 100 or 200 mm, or possibly more.

In embodiments, the injector is oriented perpendicularly (i.e. pointing toward the center of the furnace) or tangentially to the furnace wall. In preferred embodiments, an angle between the injector and the furnace wall is comprised between 50° and 90°. Angles lower than 50° may give rise to space problems inside the furnace. The tangential orientation helps to create a swirl flow in the furnace, which helps increase the distribution of the gas and the mixing with the ascending gas from tuyere level, and also increases the residence time of the gas in the furnace thus enhancing the gas utilization.

According to the same or other embodiments, the gas injection system further comprises at least one guide sleeve, the guide sleeve being fixed to the furnace wall and traversing the furnace wall and the stave. The injector is received in the guide sleeve and protrudes therefrom in the furnace. Advantageously, this sleeve protects the cooling elements of the furnace during an exchange of an injector during operation. The guide sleeve prevents descending burden from being been trapped between the injector and a stave during the exchange process, reducing the risk of a major damage.

The gas injection system may further comprise at least one mounting sleeve fixed to the furnace wall and protruding inside the furnace; the guide sleeve extending in the mounting sleeve.

According to yet another aspect, the present disclosure also relates to a shaft furnace, in particular a blast furnace, comprising:
a metal shell defining a furnace wall;
at least one tuyere arranged at a tuyere level to inject hot gas into the shaft furnace, and
a gas injection system according to the present disclosure comprising at least one injector,
wherein the at least one injector is arranged at an injection level above the tuyere level.

It remains to be noted that the present injector can be used with diverse operation modes of the shaft/blast furnace.

The hot reducing gas can generally be a gas containing predominantly (>50 vol. %) of reductant species such as CO or H₂. In particular the reducing gas can be “syngas”. The reducing gas may be injected into the furnace via the injector at a temperature comprise between 600 and 1200 °C, in particular 800 and 1200 °C. The reducing gas injection may be performed at a speed between 40 and 200 m/s.

Injection of the hot reducing gas is generally carried out with a plurality of injectors according to the present disclosure, which are distributed peripherally around the shaft/blast furnace, preferably within a distance of 0.5 to 2.5 m between the injectors. Such equally distanced injectors allow for equal distribution of the injected gas over the circumference of the furnace and further helps to center the ascending gas streaming up in the furnace and coming from the bosh area.

Conventionally, the gas injected via the tuyere at the tuyere level may be hot blast, in order to burn the coke in the burden. Alternatively, hot reducing gas (e.g. syngas) can be injected via the tuyeres at relatively high temperatures, together or not with oxygen.

### BRIEF DESCRIPTION OF THE DRAWINGS

The present disclosure will now be described, by way of example, with reference to the accompanying drawings, in which:

FIG. 1: is a first perspective schematic view of an embodiment of the inventive injector;

FIG. 2: is a second perspective schematic view of the inventive injector;

FIG. 3: is a cross-sectional schematic view of the injector of FIG. 2;

FIG. 4: is a detailed perspective schematic view of a part of the injector of FIG. 2; and

FIG. 5: is an exploded perspective schematic view of the injector of FIG. 2.

### DETAILED DESCRIPTION OF THE DRAWINGS

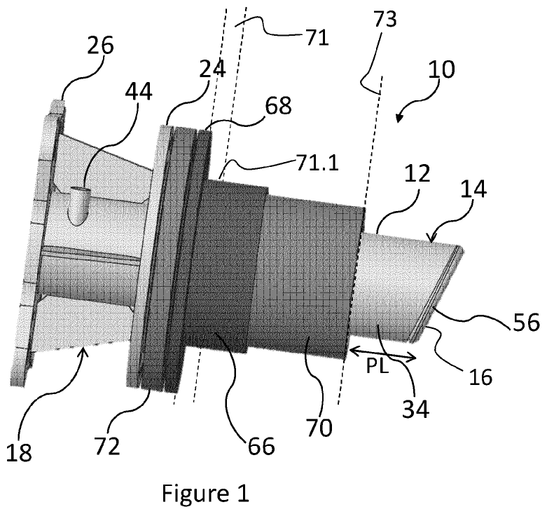

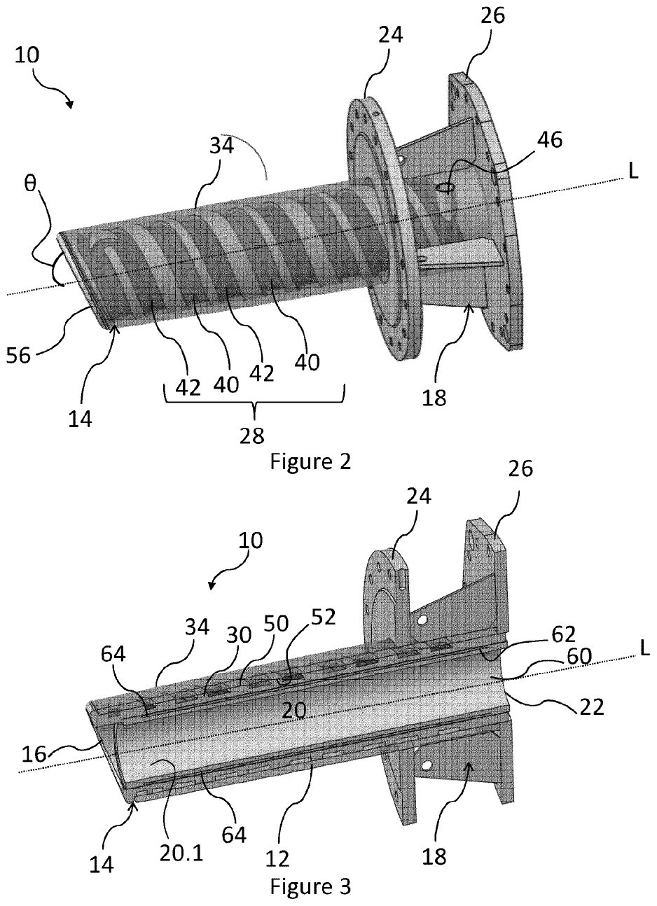

FIGS. 1 to 5 show different views of an embodiment of an injector 10 according to the present disclosure.

The gas injector 10 is designed for injecting a heated reduction gas in a furnace, in particular a blast furnace, although it may generally be used for injecting a hot gas in a furnace or reactor, in particular a metallurgical furnace/reactor. Injector 10 comprises a tubular body 12, (or injector body) extending along a main axis L from a nose (front) portion 14, with e.g. one injection hole or outlet orifice 16 (could be more), to an opposite (rear) mounting portion 18. The tubular body 12 includes an inner gas passageway 20 for guiding the hot/heated reduction gas from an inlet orifice 22 in/at the mounting portion 18 to the injection hole 16. The tubular body 12 is generally made from steel or steel-alloy or metallic-alloy. In practice, the inlet orifice 22 is coupled via appropriate piping/ducts to a source of hot gas, namely hot reducing gas (not shown)

The mounting portion 18 comprises a mounting flange 24 extending radially from the tubular body 12 for mounting, i.e. fixing, at least indirectly, the injector 10 to a furnace wall portion, typically the furnace outer wall/shell (not shown). The mounting portion 18 further comprises a connecting flange 26 extending radially from the tubular body 1 and surrounding the inlet opening 22, for connecting the injector to a corresponding flange of a reduction gas supply pipe of a gas injection system (not shown). Other types of connection means for connecting the inlet orifice 22 of injector 10 to a supply piping may also be used.

The injector 10 or its tubular body 12 comprises a cooling system 28 such as cooling channels connected to a coolant circulation system (not shown), especially if parts surrounding the injection hole or outlet orifice 16 protrude inside the blast furnace in a mounted state of the injector 10.

It shall be appreciated that the inventive injector 10 has a tubular body 12 that is comprised of two tubes, i.e. an inner tube 30 and an outer tube 34. As can be seen, the outer tube 34 defines the outer wall of the injector, whereas the inner tube 30 defines the gas passageway 20.

The tubular body 12 comprises a feed coolant channel 40 and a return coolant channel 42 defined between the inner 30 and outer 34 tubes. The feed 40 and return 42 channels are formed as interlaced helical channels extending in the main direction (defined by the axis L) in a same layer. The feed channel 40 extends from an inlet port 44 at the mounting portion 18 to the nose 14 of the tubular body 12 and the return channel 42 extends from the nose portion 14 to an outlet port 46 at the mounting portion 18 of the tubular body 12. The inlet and outlet ports 44 and 46 open through the outer tube 34. The feed 40 and return 42 channels are fluidly connected to each other at the nose portion 14. As can be seen from the drawings, since the feed and return channels are interlaced, they are arranged next to one another within the same layer. Hence, they are on a same level, the feed and return channels extending adjacent to another over the length of the tubular body 12, forming a single layer structure.

In other words, the feed and return channels are delimited in transverse direction (transverse to main axis L) by the inner 30 and outer 34 tubes. The feed and return channels are two separate flow paths for the coolant, that are intertwined or alternated within the same layer (i.e. not one above the other) defined by the inner 30 and outer 34 tubes. The feed and return channels surround the gas passageway 20.

Inner 30 and outer 34 tubes are shaped/configured in order to cooperate with each other to define the feed 40 and return 42 coolant channels. In the shown embodiment, an outer surface 50 of the inner tube 30 comprises two interlaced helical grooves 48.1, 48.2 respectively defining the feed 40 and return 42 coolant channels. Thereby the grooves are separated by helical ridges 48.3. In such embodiment, an inner surface 52 of the outer tube 34 is smooth and closes the coolant channels. However, other configurations are possible, e.g. the outer surface of the inner tube 30 may be smooth while the inner surface of the outer tube 34 may be machined so as to comprise the two interlaced helical grooves.

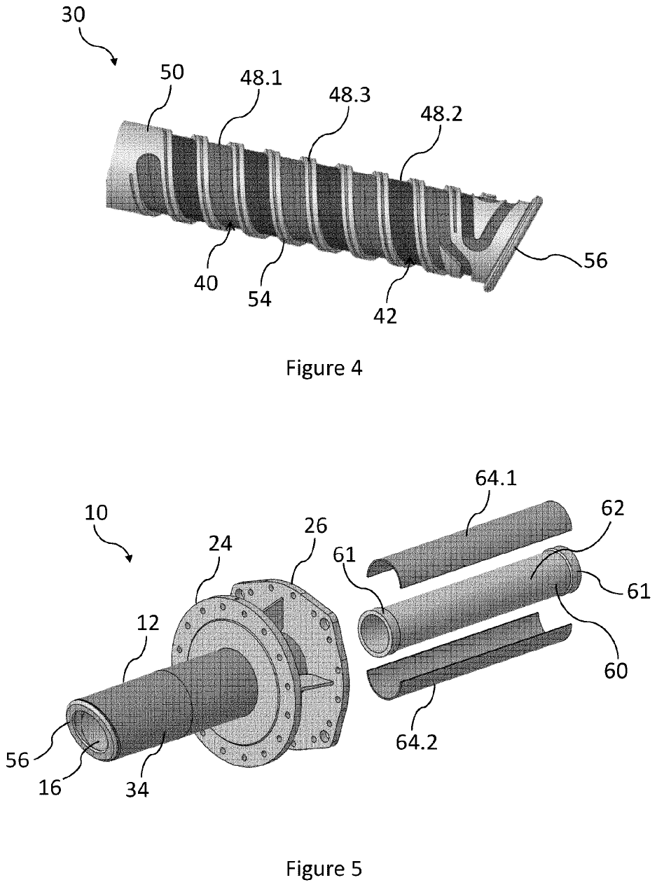

A sealing arrangement is provided between the inner 30 and outer 34 tubes of the tubular body 12. According to the embodiment of FIG. 4, the sealing arrangement comprises a helical seal 54 interposed between the two helical grooves 48.1, 48.2. The seal 54 is arranged in a groove in the helical ridge 48.3. The seal 54 may generally be made from any suitable material, but water-swellable materials, such as water-swellable fibers, are preferred. The inner and outer tubes are fixed with respect to one another and assembled in a sealed manner. For example, the inner and outer tubes can be welded at their axial extremities, which also provides the desired water seal.

The nose portion 14 of the injector tubular body 12 further comprises an end face 56 in which the outlet orifice 16 is arranged. The end face 56 is inclined relative to the main L axis, such that an angle θ is formed between the end face 56 and the main L axis, and in use the end face is turned downwards. The angle θ may e.g. be between 10 and 60°. According to the shown embodiment, the end face 56 is flat, however other configurations are possible, and the end face may be e.g. curved.

The injector 10 is exposed to substantial heat in use and inside the furnace. Therefore, a protective insert 60 acting as insulating layer, preferably ceramic or refractory based, is advantageously arranged inside the inner tube 30, hence in the passageway 20 of the tubular body 12. The protective insert 60 is of tubular/cylindrical shape and protects the inner surface of the inner tube 30, while leaving a central passage 20.1 for the flow of reduction gas through the injector. An outer diameter of the protective insert 60 is generally dimensioned to correspond, with some clearance, to an inner diameter of the inner tube 30 of the tubular body 12. The protective insert 60 may generally be made of ceramics or dense ceramics, e.g. oxide ceramics, in particular magnesia, alumina, zirconia or silicon carbide. An intermediate layer of thermal insulation material 64 can be arranged between the inner tube 30 and the protective insert 60. In this variant, an outer surface of the protective insert comprises a recess 62, i.e. the insert 60 has a recessed outer surface, and the thermal insulation material 64 is arranged in the recess 62. As seen in FIG. 5, protective insert has a tubular shape with two end shoulders 61 on its outer surface, which axially delimit the annular recess 62. The thermal insulation material 64 is configured as two half cylinders 64.1, 64.2 that fit within the annular recess 62 on the outer surface of the protective insert 60 (FIG. 5). However, other configurations are possible and the thermal insulation material may be provided with any other shape such as e.g. a cylindrical sleeve, the protective insert being inserted inside the sleeve-shaped insulation material. The thermal insulation layer may be made of any suitable heat insulation material, such as e.g. oxide ceramic.

In a mounted state, as illustrated in FIG. 1, the injector 10 is arranged to protrude slightly in the inside of a blast furnace. A blast furnace conventionally comprises a hearth and a shaft-forming steel shell 71 (shown in dashed lines) extending vertically above the hearth. The steel shell constitutes the furnace outer wall. Its inner surface (i.e. towards the furnace interior) is generally covered with cooling plate (or staves). Such cooling plates typically have a slab-like body made from steel or copper (alloy) with internal coolant channels through which a coolant (water) is circulated. The front side of the cooling plates (i.e. facing the furnace interior) is also generally covered with a protective layer of steel blades inserts or refractory material (not shown). Dashed line 73 in FIG. 1 illustrates the inner side of the protective lining formed e.g. by the cooling plate with or without inserts/refractory material and LP designates the protruding length, which may be of about 50, 100 or 200 mm, or above.

The mounted injector 10 protrudes in the inside of the furnace through a corresponding aperture in the shell in such a way that the nose portion 14 with the outlet orifice 16 is located inside the furnace, whereas the mounting portion 18 is outside the outer wall. In case of the presence of cooling plates, these cooling plates are provided with corresponding apertures (bores through their thickness), and the injector is arranged through these apertures. The injector body 12 extends through the apertures in the furnace shell (aperture 71.1) and cooling plate (protective lining 71) and protrudes (over length LP) from the cooling plates inside the furnace.

The injector 10 is attached in a gas tight manner with the mounting flange 24 to the aperture 71.1 in the furnace shell 71. For ease of installation and sealing purposes, a mounting sleeve 66 (made from steel, ceramic material or suitable metal alloys) can be arranged to extend in the two apertures. The mounting sleeve 66 has an outer diameter corresponding to the diameter of the two apertures (i.e. in outer shell and cooling plate) and a length adapted for guiding through the shell 71. The mounting sleeve 66 comprises a respective mounting flange 68 fixed to the furnace wall in any suitable manner (e.g. bolted or welded, in a gas-tight manner).

A guide sleeve 70, with a respective flange 72, may further be fixed to the furnace outer wall and arranged to extend through the furnace wall and protective lining (cooling element and/or refractory). The guide sleeve 70 extends in the mounting sleeve 66 and receives the injector 10, which protrudes therefrom in the furnace. The guide sleeve 70 gas a length corresponding to the distance from the shell's outer side up to the front side 71 or the protective lining.

The injector 10 may be mounted in any suitable manner to the furnace wall. The injector may be oriented perpendicularly (pointing to the center of the blast furnace) or tangentially to the blast furnace wall (i.e. at any angle below 90°, preferably at an angle above 50° relative to the blast furnace wall at the location of the injector).

1. An injector for injecting a hot gas into a metallurgical furnace or reactor, the injector comprising:
a tubular body extending along a main axis between a mounting portion configured for fixing the injector to the furnace and a nose portion to be arranged inside the furnace, the tubular body comprising an inner gas passageway for guiding a heated gas from an inlet orifice at the mounting portion to at least one outlet orifice at the nose portion;
wherein the tubular body includes a feed coolant channel and a return coolant channel defined between cooperating inner and outer tubes, wherein the feed and return coolant channels are formed as interlaced helical channels extending in the main axis direction in a same layer.

2. The injector according to claim 1, wherein
said inner tube comprises two interlaced helical grooves that define the feed and return channels, the helical grooves extending from the mounting portion to the nose portion, the two helical grooves being fluidly connected at the nose portion; and
wherein an inlet port is arranged at the mounting portion connecting the first helical groove;
an outlet port is arranged at the mounting portion connecting the second helical groove.

3. The injector according to claim 1, wherein a ratio between an outer diameter of the outer tube and an inner diameter of the inner tube is less than 2.5.

4. The injector according to claim 1, wherein the nose portion comprises an end face in which said at least one outlet orifice is arranged, said end face being at least partially inclined relative to the main axis, such that in use the end face is turned downwards.

5. The injector according to claim 4, wherein said end face is flat or curved; and wherein an angle between the end face and the main axis is comprised between 10° and 60°.

6. (canceled)

7. The injector according to claim 1, comprising a sealing arrangement between the inner and outer tubes.

8. The injector according to claim 7, wherein the sealing arrangement comprises a helical seal interposed between the two helical grooves; and wherein the helical seal comprises water-swellable material.

9. (canceled)

10. The injector according to claim 1, further comprising a tubular, protective insert arranged in the passageway of the tubular body; wherein the protective insert is made of thermal insulation material, stress-resistant material, or chemically resistant material.

11. (canceled)

12. The injector according to claim 10, wherein a thermal insulation material is arranged between the tubular body and the protective insert.

13. The injector according to claim 12, wherein the tubular protective insert has a recessed outer surface, and said thermal insulation material is provided as a peripheral layer in said recessed outer surface.

14. The injector according to claim 13, wherein said thermal insulation material is provided as two half cylinders that fit within said recessed outer surface.

15. (canceled)

16. The injector according to claim 1, further comprising a mounting flange radially extending from the tubular body for fixing, at least indirectly, the injector to a furnace outer wall.

17. The injector according to claim 1, further comprising a connecting flange surrounding the mounting portion for connecting the injector to a corresponding flange of a reduction gas supply pipe of a metallurgical furnace gas injection system.

18. (canceled)

19. A gas injection system for a furnace or reactor comprising a furnace wall with a protective layer, the gas injection system comprising at least one injector as claimed in claim 1, wherein the injector traverses the furnace wall and the protective layer.

20. The gas injection system of claim 19, wherein the injector is oriented perpendicularly or tangentially to the furnace wall.

21. The gas injection system of claim 19, further comprising at least one guide sleeve, wherein the guide sleeve is fixed to the furnace wall and traverses the furnace wall and the stave, and wherein the injector is received in the guide sleeve and protrudes therefrom in the furnace.

22. The gas injection system of claim 21, further comprising at least one mounting sleeve fixed to the furnace wall and protruding inside the furnace; the guide sleeve extending in the mounting sleeve.

23. The gas injection system of claim 19, wherein the feed coolant channel is connected to a source of coolant fluid and the return coolant channel is connected to a coolant collector duct.

24. The gas injection system of claim 19, wherein the protective layer comprises cooling elements or refractory material, and wherein the gas injector(s) is/are arranged such that the nose portion is flush with respect to the inner side of the protective layer, or protrudes by a distance relative to the latter.

25. A shaft furnace comprising:
a metal shell defining a furnace wall;
at least one tuyere arranged at a tuyere level to inject hot gas into the shaft furnace; and
a gas injection system as claimed in claim 19,
wherein the at least one injector is arranged at an injection level above the tuyere level.
